(19) United States
(12) Patent Application Publication
(10) Pub. No.: US 2016/0274752 A1
(43) Pub. Date: Sep. 22, 2016

(54) Optical Head-Mounted Display for Controlling an Implantable Medical Device and Communication Accessory Attachable Thereto

(71) Applicant: Boston Scientific Neuromodulation Corporation, Valencia, CA (US)

(72) Inventors: Changfang Zhu, Valencia, CA (US); Sridhar Kothandaraman, Valencia, CA (US); Goran N. Marnfeldt, Valencia, CA (US); Yue Li, Sherman Oaks, CA (US)

(21) Appl. No.: 15/007,768

(22) Filed: Jan. 27, 2016

Related U.S. Application Data
(60) Provisional application No. 62/135,373, filed on Mar. 19, 2015.

(51) Int. Cl. G06F 3/0484; G06F 13/42; G02B 27/01; H04W 4/00; G06F 3/01; G06F 3/16

(52) U.S. Cl. CPC G06F 3/0484; G06F 3/017; G06F 3/167; G02B 27/0176; G02B 27/0172; H04W 4/008; G06F 13/4282; G02B 2027/0141

(57) ABSTRACT

An Optical Head-Mounted Display (OHMD) for use as external controller for an Implantable Medical Device (IMD) is disclosed which includes an IMD communication accessory with a USB connector coupleable to a USB port on the OHMD. The accessory includes a housing with a communication antenna and telemetry transceiver circuitry to allow for direct communications with the IMD. The housing includes a battery for powering the transceiver circuitry and antenna. A cable may be coupled to the housing to allow the housing to be located proximate to patient's IMD when the communication means used in the IMD is relatively short range (e.g., magnetic induction). The housing may be cableless and comprise a dongle coupleable to a port on the OHMD if the communication means provided in the housing and used in the IMD are longer range (e.g., MICS).

### CROSS REFERENCE TO RELATED APPLICATIONS

This is a non-provisional application of U.S. Provisional Patent Application Ser. No. 62/135,373, filed Mar. 19, 2015, which is incorporated herein by reference, and to which priority is claimed.

### FIELD OF THE INVENTION

The present invention relates generally to implantable medical device systems, and more particularly to external systems and methods for communicating with an implantable medical device.

### BACKGROUND

Implantable stimulation devices deliver electrical stimuli to nerves and tissues for the therapy of various biological disorders, such as pacemakers to treat cardiac arrhythmia, defibrillators to treat cardiac fibrillation, cochlear stimulators to treat deafness, retinal stimulators to treat blindness, muscle stimulators to produce coordinated limb movement, spinal cord stimulators to treat chronic pain, cortical and Deep Brain Stimulators (DBS) to treat motor and psychological disorders, and other neural stimulators to treat urinary incontinence, sleep apnea, shoulder subluxation, etc. The description that follows will generally focus on the use of the invention within a Spinal Cord Stimulation (SCS) system, such as that disclosed in U.S. Pat. No. 6,516,227. However, the present invention may find applicability with any Implantable Medical Device (IMD) or in any IMD system.

As shown in FIG. 1, a SCS system includes an Implantable Pulse Generator (IPG) 10 (hereinafter, and more generically, IMD 10), which includes a biocompatible device case 12 formed of titanium for example. The case 12 typically holds the circuitry and battery 14 necessary for the IMD 10 to function. The IMD 10 is coupled to electrodes 16 via one or more electrode leads 18 (two of which are shown). The proximal ends of the leads 18 are coupled to the IMD 10 at one or more lead connectors 20 fixed in a header 22, which can comprise an epoxy for example. In the illustrated embodiment, there are sixteen electrodes, although the number of leads and electrodes is application specific and therefore can vary. In an SCS application, two electrode leads 18 are typically implanted on the right and left side of the dura within the patient's spinal column. The proximal ends of the leads 18 are then tunneled through the patient's flesh to a distant location, such as the buttocks, where the IMD case 12 is implanted, at which point they are coupled to the lead connectors 20.

Cross sections of two examples of IMD 10, 10a and 10b, are shown in FIGS. 2A and 2B. Both contain a charging coil 24 for wirelessly charging the IMD's battery 14 using an external charging device (not shown). (If battery 14 is not rechargeable, charging coil 26 can be dispensed with). Both IMDs 10a and 10b also contain control circuitry such as a microcontroller 26, telemetry circuitry 28 (discussed further below), and various components 30 necessary for IMD operation, such as stimulation circuitry for forming therapeutic pulses at the electrodes 16. The charging coil 24, battery 14, microcontroller 26, telemetry circuitry 28, and other components 30 are electrically coupled to a printed circuit board (PCB) 32.

Different in the two IMDs 10a and 10b are the telemetry antennas 34a and 34b used to transcutaneously communicate data through the patient's tissue 36 with devices external to the patient. In IMD 10a (FIG. 2A), the antenna comprises a coil 34a, which can bi-directionally communicate with an external device along a magnetic induction communication link 38a, which comprises a magnetic field of typically less than 10 MHz operable in its near-field to communicate at a distance of 12 inches or less for example. Telemetry circuitry 28a is electrically coupled to the coil antenna 34a to enable it to communicate via magnetic induction link 38a, and generally includes driver circuitry for energizing the coil antenna 34a to transmit data and amplifier/filter circuitry for resolving data received at the coil 34. Telemetry circuitry 28a generally also operates in accordance with a modulation scheme (defining how data to be transmitted is modulated on the link 38a and will be demodulated when received) and a communication protocol (defining the manner in which the data is formatted). Telemetry circuitry 28a receives the data to be transmitted in digital form from the microcontroller 26, and provides received digital data to the microcontroller 26 for interpretation. A typical modulation scheme used by telemetry circuitry 28a is Frequency Shift Keying (FSK), although other modulation schemes could also be used. In FIG. 2A, the external device would also contain communication means (e.g., a coil antenna; telemetry circuitry) compatible with the magnetic induction communication link 38a and the protocol used by the IMD 10a, as explained subsequently.

In IMD 10b (FIG. 2B), short-range Radio Frequency (RF) communication means—including short-range RF antenna 34b and compliant short-range RF telemetry circuitry 28b—are provided that operate in accordance with a short-range RF communication standard and its underlying protocols to bi-directionally communicate with an external device along a short-range RF communication link 38b. Short-range RF communication link 38b typically operates using far-field electromagnetic waves ranging from 10 MHz to 10 GHz or so, and allows communications between devices at distances of about 50 feet or less. Short-range RF standards supported by short-range RF telemetry circuitry 28b and antenna 34b include, for example, Bluetooth, BLE, NFC, Zigbee, WiFi (802.11x), and the Medical Implant Communication Service or the Medical Device Radiocommunications Service (both collectively referred to herein as “MICS” for short). Short-range RF antenna 34b can take any number of well-known forms for an electromagnetic antenna, such as patches, slots, wires, etc., and can operate as a dipole or a monopole. The external device in FIG. 2B would also contain short-range RF communication means compatible with short-range RF link 38b and the standard/protocols used in IMD 10b, as explained subsequently.

Although both of antennas 34a and 34b in IMDs 10a and 10b are shown in FIGS. 2A and 2B inside of case 12, they may also be placed within the IMD's header 22, or on the outside of the case 12. Although shown as exclusive in FIGS. 2A and 2B, an IMD 10 may have both of the different types of antennas 34a and 34b.

Different configurations for external devices used to communicate with IMDs such as 10a and 10b exist in the prior art. Such external devices are typically used to adjust the therapy settings the IMD 10a or 10b will provide to the patient (such as which electrodes 16 are active to issue pulses; whether such electrodes sink or source current (i.e., polarity); the duration, frequency, and amplitude of pulses, etc.), which settings together comprise a stimulation program for the patient. External devices can also act as receivers of data from the IMD 10a or 10b, such as various data reporting on the IMD's status and the level of the IMD's battery 14.

An external device having such functionality is shown in FIG. 3 in the form of a patient remote control 40. Remote control (RC) 40 is typically hand-held, portable, and powered by a battery (not shown) within the RC's housing 41, which battery may be a primary battery or rechargeable. The RC 40 includes a Graphical User Interface (GUI) 43 similar to that used for a cell phone, including buttons 42 and a screen 44, and may have other user interface aspects as well, such as a speaker. The RC 40 also includes within its housing 41 communication means, including a coil antenna 49a and/or a short-range RF antenna 49b, compatible with the link(s) 38a and/or 38b and the communication means used in the IMDs 10a and/or 10b. Processing in the RC 40 is controlled via a microcontroller 46. As described above with respect to the IMDs 10a and 10b, antennas 49a and 49b would be associated with compliant telemetry circuitry, although such circuitry is not shown in FIG. 3. RC 40 can include a port 45 on its housing 41, which may comprise a USB port for example. See, e.g., U.S. Pat. Nos. 8,498,716; 8,588,925.

Shown on the screen 44 in FIG. 3 are various options provided by the GUI 43 and selectable by a patient to control his IMD 10 (e.g. the stimulation program it is executing) or to monitor his IMD 10. Just a few typical options are depicted for simplicity that enable the patient to: start or stop stimulation; increase or decrease the amplitude of the stimulation pulses; check IMD monitoring information, such as the battery 14 level, operating status of the IMD, or other data telemetered from the IMD; etc.

External devices such as the RC 40 of FIG. 3 were historically built by the manufacturers of IMDs, and thus were generally dedicated to communicate only with such IMDs. As such, dedicated RC 40 is not freely programmable by a patient, but is instead limited to the IMD functionality provided by the manufacturer. (However, the microcode operating in the RC's microcontroller 46 may be upgraded from time to time in manners specified by the manufacturer). However, there are many user-programmable commercial mobile devices, such as cell phones, that can provide GUIs and have inherent communication means suitable for functioning as a wireless external controller for an IMD.

FIGS. 4A and 4B show an example of a mobile device 50 configured for use as an external controller for an IMD, as described in commonly-owned U.S. Patent Application Publications 2015/0073498 and 2015/0231402. The mobile device 50 may be a commercial, multipurpose, consumer device, such as a cell phone, tablet, personal data assistant, laptop or notebook computer, or like device—essentially any mobile, hand-holdable device capable of functioning as a wireless external controller for an IMD. Examples include the Apple iPhone or iPad, Microsoft Surface, Nokia Lumia devices, Samsung Galaxy devices, and Google Android devices for example.

As shown in FIG. 4A, the mobile device 50 includes a GUI 53 with a screen 54, which may also receive input if it is a touch screen. The mobile device 50 may also have buttons 52 (e.g., a keyboard) for receiving input from the patient, a speaker 56, and a microphone 58. Mobile device 50 further includes a battery within its housing 51 (not shown) which battery may be a primary battery or rechargeable. Mobile device 50 can also include a USB port 55 and an audio port 57. Mobile device 50 further includes at least one short-range RF antenna 59, and would include telemetry circuitry compliant with that antenna(s) (not shown). Mobile device 50 may further include longer-range cellular communication means as is well known. Processing in the mobile device 50 is controlled by a microcontroller 61.

Shown on the screen 54 is a typical home screen GUI 53 provided by the mobile device 50 when first booted or reset. A number of applications (“apps”) 60 may be present and displayed as icons on the mobile device home screen GUI 53, which the patient can select and execute. One of the applications (icons) displayed in FIG. 4A is a Medical Device Application (MDA) 70, which may reside as microcode in the mobile device 50's microcontroller 61 or which may otherwise be stored in the mobile device's memory. When MDA 70 is executed by the patient, the microcontroller 61 will configure the mobile device 50 for use as an external controller to communicate with an IMD. FIG. 4B shows the GUI 73 provided by the MDA 70 after it is executed, which includes options selectable by a patient to control his stimulation program or monitor his IMD, similar to what was described earlier with respect to the GUI 43 of the dedicated RC 40 of FIG. 3.

The MDA 70, like other applications 60 selectable in the mobile device 50, may have been downloaded using traditional techniques, such as from an Internet server or an “app store.” Although not strictly necessary, MDA 70 is logically developed and provided by the manufacturer of the IMD, and may be made available in different versions to work with different mobile device operating systems (e.g., iOS, Android, Windows, etc.). One skilled in the art will understand that MDA 70 comprises instructions that can be stored in the mobile device 50 or in an Internet server on non-transistory machine-readable media, such as magnetic, optical, or solid-state discs, integrated circuits, memory sticks, tapes, etc.

While using a mobile device 50 as an external controller for an IMD has potential utility, it cannot be guaranteed that a typical general-purpose mobile device will have built-in communication means that will allow for direct wireless communication with the IMD 10. For example, the mobile device 50 may completely lack magnetic induction communication capable of communicating on link 38a, and hence may be incapable of directly communicating with the IMD 10a (FIG. 2A) and its telemetry coil 34a. A mobile device 50 is likely to have built-in short-range RF communication means in addition to its normal cellular communication ability, such as WiFi and Bluetooth communication means. However, such short-range RF communication means may not be compatible with the short-range RF communication means provided in IMD 10b (FIG. 2B) and its short-range telemetry antenna 34b.

The inventors propose solutions to such compatibility problems in the context of an external controller system for an IMD having improved patient convenience when compared to traditional mobile devices.

### BRIEF DESCRIPTION OF THE DRAWINGS

FIG. 1 shows an Implantable Medical Device (IMD) in accordance with the prior art.

FIGS. 2A and 2B respectively show cross sections of an IMD having a coil telemetry antenna and an RF telemetry antenna, in accordance with the prior art.

FIG. 3 show a dedicated remote control (RC) for communicating with an IMD, in accordance with the prior art.

FIG. 4A shows a graphical user interface (GUI) of a mobile device, and FIG. 4B shows a GUI of a Medical Device Application (MDA) on the mobile device for communicating with an IMD, in accordance with the prior art.

FIG. 5A shows an Optical Head-Mounted Display (OHMD) with a connectable IMD communication accessory for use as an external controller for an IMD having a coil telemetry antenna in FIG. 2A, and FIG. 5B shows the accessory in cross section with respect to the IMD, in accordance with an example of the invention.

FIG. 6 shows relevant circuity and software modules operable in the OHMD and in the accessory of FIG. 5A, in accordance with an example of the invention.

FIGS. 7A-7C show different configurations for the accessory of FIG. 5A, in accordance with examples of the invention.

FIG. 8 shows manners in which the OHMD the accessory of FIG. 5A can be worn by a patient having an IMD having a coil telemetry antenna as in FIG. 2A, in accordance with examples of the invention.

FIG. 9 shows an example of a Graphical User Interface (GUI) rendered on the OHMD by a Medical Device Application to allow a patient to control and/or monitor his IMD, in accordance with an example of the invention.

FIG. 10A shows an OHMD with a connectable IMD communication accessory for use as an external controller for an IMD having a short-range RF telemetry antenna as in FIG. 2B, and FIG. 10B shows the accessory in cross section, in accordance with an example of the invention.

FIG. 11 shows relevant circuity and software modules operable in the OHMD and in the accessory of FIG. 10A, in accordance with an example of the invention.

FIG. 12 shows manners in which the OHMD and accessory of FIG. 10A can be worn by a patient having an IMD having a short-range RF telemetry antenna, in accordance with examples of the invention.

### DETAILED DESCRIPTION

The inventors disclose Optical Head-Mounted Displays (OHMDs) for use as external controllers for Implantable Medical Devices (IMDs) such as an Implantable Pulse Generators (IPGs). OHMDs offer advantages as IMD external controller beyond mobile devices such as cell phones, as they can be freely and continually worn by a patient, and hence used to immediately control and/or monitor a patient's IMD, unlike a mobile phone which must be specifically handled and accessed by the patient. However, like mobile devices, an OHMD may lack the communication means necessary to directly communicate with communication means in the IMD. To address this issue, examples of accessories coupleable to a port (e.g., a Universal Serial Bus, or USB) on an OHMD are disclosed. Such accessories include a housing containing a communication antenna and transceiver circuitry to enable direct communications with the IMD. The accessories further include a battery for powering the antenna and transceiver circuitry. When the accessory is coupled to the OHMD, a patient may continually control and/or monitor his IMD via a Graphical User Interface of the OHMD in a relatively hands-free manner and as he wears the OHMD for other purposes, and without the need of carrying and specifically handling and accessing additional hardware.

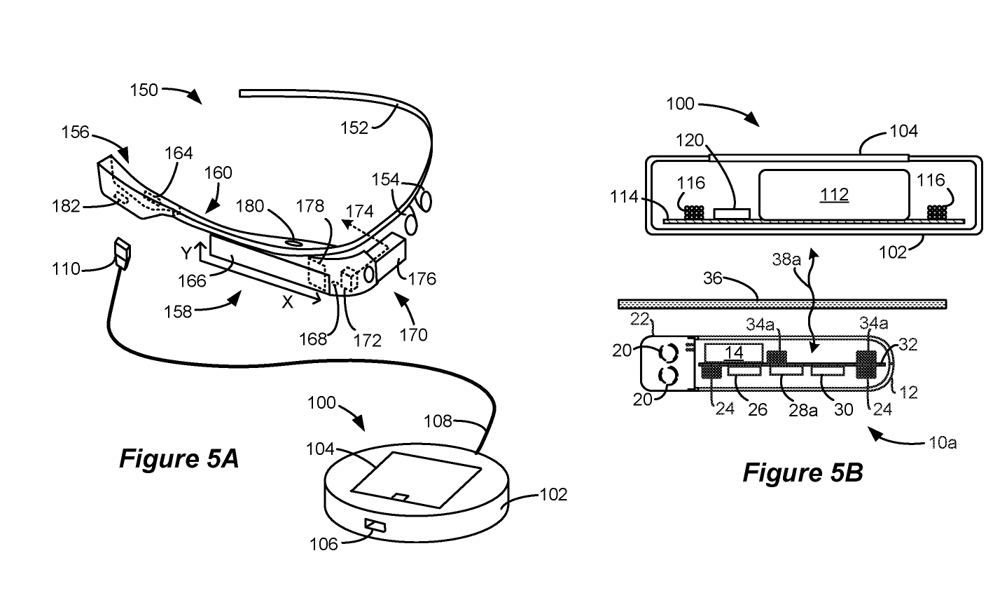

FIG. 5A shows a first example of a system for communicating with an IMD 10a having a coil antenna 34a (FIG. 2A). The system includes an OHMD 150 and an IMD communication accessory 100. In this example, the OHMD 150 comprises a Google Glass™ OHMD, developed by Google, Inc. of Mountain View, Calif., but is not so limited, and can include other OHMDs in existence or developed in the future. OHMD 150 is configured to be wearable much like a pair of standard eyeglasses, and includes nose pads 154 and a frame 152 that also serves as the temples supported by the wearer's ears. Lenses (e.g., corrective or sunglasses lenses) may be affixed to the frame 152, but are not shown in FIG. 5A. OHMD 150 may also be worn in conjunction with a wearer's normal eyeglasses.

Plastic affixed to the frame 152 generally defines a rearward housing 156 and a forward housing 158 on the OHMD 150's right temple. Plastic also defines a pass-through portion 160, which as well as defining a space for the wearer's right ear, also provides for the passing of wires between the two housings 156 and 158. The rearward housing 156 holds a rechargeable battery (not shown). A bone-conduction audio transducer 164 in the rearward housing 156 protrudes through the plastic and presses over the right ear to permit the wearer to hear sounds provided by the OHMD's user interface, which is explained further below. OHMD 150 could also include a more-traditional audio speaker as well. A USB port 182 is also included on the rearward housing 156, but could occur elsewhere as well.

The forward housing 158 supports the OHMD 150's main electronics, such as its microprocessor, and movement sensors providing input to a motion detector module in the electronics, including a three-axis accelerometer and a three-axis gyroscope. Also included in the forward housing 158 is a touch sensor (not shown), which allows the outer surface of the forward housing to operate as a touch pad 166. The touch pad 166 is sensitive to the wearer's touch across the two-dimensional expanse (X and Y) of the outer surface of the foreword housing 158, and can additionally be pressed (“tapped”) similar to a button. The underside of the forward housing 158 additionally includes a microphone 168 for the receipt of voice input in addition to inputs receivable by the touch pad 166. The electronics of the OHMD 150 preferably includes a voice detection module for interpretation of spoken voice inputs received at microphone 168.

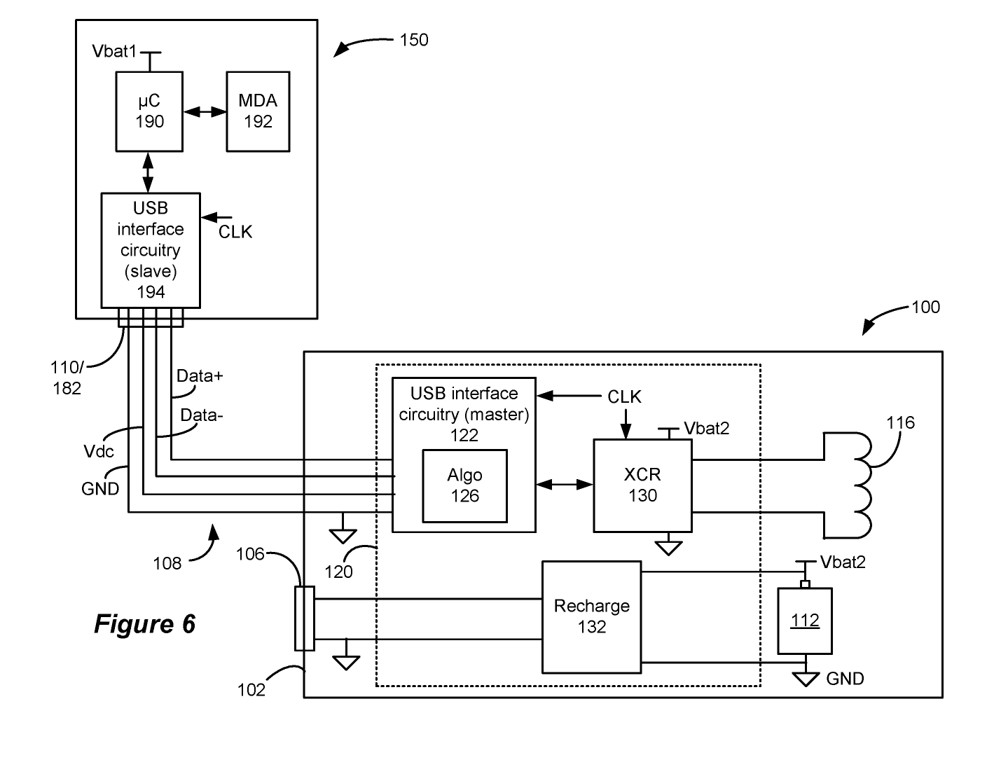

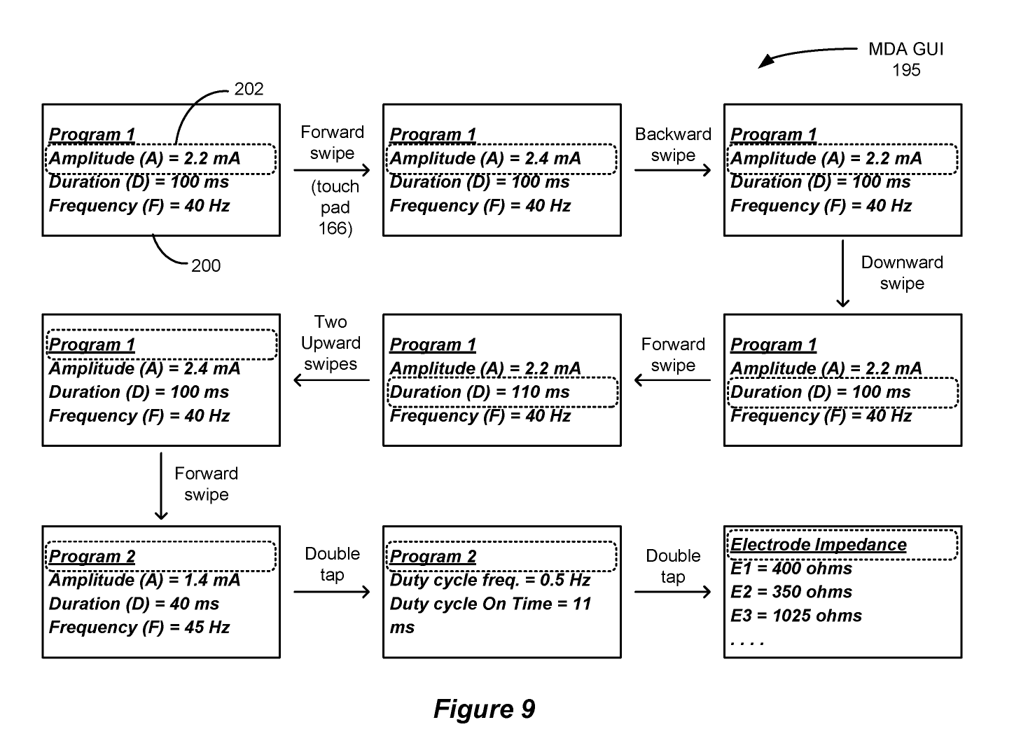

The forward housing 158 also includes a display portion 170 proximate to the wearer's right eye including an LED array 172 powered by the OHMD's microprocessor. Images 174 created by the LED array 172 are directed to a prism 176 containing a polarizing beam-splitter that directs the images 174 to the wearer's right eye. In this manner, the user is able to perceive the images 174 generated by the OHMD 150 and output by the display portion 170, which images 174 are provided slightly to the right of the wearer's center of vision, thus allowing the wearer to see the real world and the images on the display portion 170 simultaneously. As discussed further below, the display portion 170 can be used, in conjunction with a Medical Device Application (MDA) 192 (FIG. 6), to render an MDA Graphical User Interface (GUI) 195 (FIG. 9) allowing a patient to control and/or monitor his IMD.

OHMD 150 may further include bi-directional short-range RF communication means, which like the mobile device 50 described earlier preferably includes one or more antennas 178 and telemetry circuitry (not shown) compliant with Bluetooth and Wi-Fi communication standards for example. The antenna 178 is shown located in the forward housing 158, but could be present elsewhere.

A first example of IMD communication accessory 100 is shown in FIGS. 5A and 5B in perspective and cross-sectional views respectively. As shown, the accessory 100 comprises a housing 102 formed of hard plastic for example. A printed circuit board (PCB) 114 (FIG. 5B), which may be secured inside the housing 102 in a variety of well-known ways, is provided to integrate various circuitry 120 in the accessory 100, which circuitry 120 is discussed subsequently. Also preferably located in housing 102 and coupled to the circuitry 120 are a battery 112 and a communication coil (antenna) 116. A removable battery cover 104 may provide access to the battery 112 allowing it to be replaced if it is a primary battery. If battery 112 is rechargeable, a battery cover 104 may not be necessary, and instead battery 112 may be recharged by providing power at port 106 (e.g., a USB port) on the housing 102. The battery 112 provides the power to allow for communications along magnetic induction communication link 38a as well as to power the circuitry 120, as explained further below. Although communication coil (antenna) 116 is shown within the housing 102, it may also be positioned outside or on the external surface of the housing 102. Moreover, although it is preferred that the accessory 100 have its own battery 112 as discussed further below, this is not strictly necessary, and instead the accessory 100 may receive power from the OHMD 150 (e.g., its battery; not shown).

A cable 108 (FIG. 5A) couples the electronics in the housing 102 to a USB connector 110, which connects to the USB port 182 on the OHMD 150. USB port 182 may also be used for other purposes, such as to recharge the OHMD 150 battery (not shown). Although port 182 and connector 110 in this example are configured and operate pursuant to a USB protocol, this is not strictly necessary, and other non-USB configurations and protocols could be used as well.

The IMD communication accessory 100 can completely lack a user interface, because the accessory 100 can leverage the user interface provided by the OHMD 150, as explained further below. That being said, additional user interface elements (e.g., audio or visual indicators, switches) could be provided with the accessory 100 as well. For example, the housing 102 may include one or more user interface elements to indicate when the communication coil 116 is active; to indicate the quality of the communication link 38a; to indicate the status of the battery 112, etc.

FIG. 6 shows circuitry used in the IMD communication accessory 100 and the OHMD 150. As shown, the OHMD 150 includes control circuitry (e.g., a microcontroller 190), and a Medical Device Application (MDA 192). The functionality of MDA 192 is discussed in further detail later, but is generally similar to the MDA 70 discussed earlier (FIGS. 4A & 4B) and allows a patient to control and/or monitor his IMD. MDA 192 may comprise one of many applications executable in the OHMD 150, and again may have been downloaded to the OHMD 150 using the OHMD's built-in telemetry circuitry (e.g., Bluetooth or Wi-Fi). MDA 192, like MDA 70, again comprises instructions that can be stored in machine-readable media in the OHMD 150 (or in the control circuitry 190) or on an Internet server for download.

The USB port 182 of the OHMD 150 is coupled to USB interface circuitry 194, and is likely programmed to operate as a slave in accordance with USB protocols. Use of slave USB interface circuitry 194 in OHMD 150 allows the OHMD to be controlled by another computer device, such as a personal computer, which can operate as a master to control USB communications at port 182.

In recognition of the possible nature of the OHMD 150 as a USB slave, the IMD communication accessory 100 preferably includes programmable USB interface circuitry 122 operating as a master to control communications on cable 108 when accessory's connector 110 is connected to port 182 on the OHMD 150. An algorithm 126 associated with the master USB circuitry 122 in the accessory 100 can operate to handshake with the OHMD 150 along USB data lines Data+ and Data−. Algorithm 126 may further cause the OHMD to execute MDA 192 to automatically render its MDA GUI 195 (FIG. 9), thus allowing the patient immediate access to this GUI to communicate with his IMD 10a once the accessory 110 has been connected. Alternatively, the MDA 192 may run in the background on the OHMD 150 to detect the accessory 100 and to automatically render the MDA GUI 195 at that time. Note that USB interface circuitries 194 and 122 could also be programmed into control circuitry (e.g., 190) operable in the OHMD 150 and accessory 100. Moreover, whether the OHMD 150 or accessory 100 acts as master or slave can be changed.

Once communication between the OHMD 150 and the IMD communication accessory 100 is established, and the MDA GUI 195 rendered, the patient may use the MDA GUI 195 to communicate data to and from his IMD 10a via the communication coil 116 in the accessory. In this regard the accessory 110 includes transceiver circuitry 130 operable in accordance with the communication modulation/demodulation scheme and protocol used by the IMD 10a on magnetic induction communication link 38a, for example Frequency Shift Keying as described earlier. The transceiver circuitry 130 is preferably powered by the battery 112 in the accessory 100. Power for the transceiver circuitry 130 could alternatively come from the battery (Vbat1) operable in the OHMD 150 via power supply line Vdc, but this is not preferred as the battery in the OHMD 150 may not have a sufficient capacity for FSK communications along link 38a. Note that battery 112 in the accessory 100 may comprise a rechargeable battery, and thus accessory 110 may include battery recharging circuitry 132 to allow the battery 112 to be recharged as necessary, via port 106 for example.

Although not shown, the IMD communication accessory 100 may also include control circuitry, such as a microcontroller, although this is not strictly necessary as USB interface circuitry 122 and transceiver 130 alone can be sufficient for the transmission and reception of data to and from the IMD 10a. If necessary, well-known simple clocking circuitry (e.g., a crystal or ring oscillator, a phase locked loop, etc.) could be used to generate a clock signal (CLK) for the USB and transceiver circuitries 122 and 130.

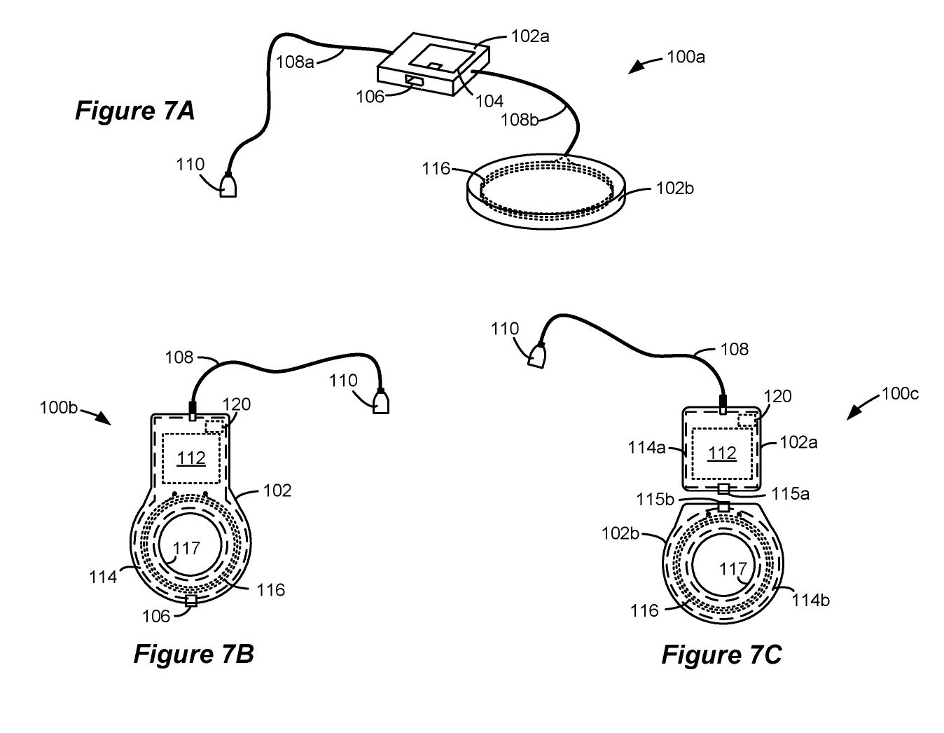

FIG. 7A shows an alternative IMD communication accessory 110a for communicating with IMD 10a via magnetic induction communication link 38a (FIG. 2A) in which the electronics and the communication coil 116 are separated. Specifically, two housings 102a and 102b are provided, with housing 102b containing only the communication coil 116, and with housing 102a containing battery 112 and other circuitry 120 such as the USB interface circuitry 122, the transceiver circuitry 130, and the battery recharge circuitry 132. Such separation also separates the cable, with cable portion 108b appearing between the two housings 102a and 102b, and cable portion 108a appearing between housing 102a and the connector 110. Circuitry housing 102a may include the battery cover 104 and charging port 106 referred to earlier. Coil housing 102b may be formed of a more-comfortable deformable material such as silicone in this example.

The charging coil accessory 100a of FIG. 7A is beneficial because it removes accessory electronics from the area extent of the communication coil 116, which electronics can otherwise potentially interfere with communication on magnetic induction communication link 38a. Other examples of charging coil assemblies providing this same benefit are shown in FIGS. 7B and 7C. In accessory 100b of FIG. 7B, the battery 112 is in the same housing 102 as the communication coil 116, but moved to the side of the coil. In this regard, a larger PCB 114 is provided for supporting and electrically coupling the battery 112, circuitry 120, and the communication coil 116. Housing 102 may include a hole 117 in the center of the communication coil 116. Although not shown, the housing 102 may again include a battery cover (like 104, FIG. 5A) to permit access to the battery 112. Port 106 may again be provided to allow for recharging of the battery 112 in the accessory 100a.

The IMD communication accessory 100c of FIG. 7C incorporates the battery 112 and electronics 120 in a different housing 102a than the housing 102b for the communication coil 116, similar to accessory 100a of FIG. 7A. However, the housings 102a and 102b can connect via a port 115a and connector 115b instead of by a flexible cable (compare 108b in FIG. 7A). Housing 102b can again comprise a hole 117. The port 115a and connector 115b allow the housings 102a and 102b to click together for mechanical robustness, such that such housings will touch to form an integrated battery/coil structure. However, this is not strictly necessary, and instead a cable can be used to couple 115a and 115b. Note that 115a could alternatively comprise a connector, and 115b a port. Again, housing 102a may include a battery cover for permitting access to the battery 112. Port 115a may be used to recharge the battery 112.

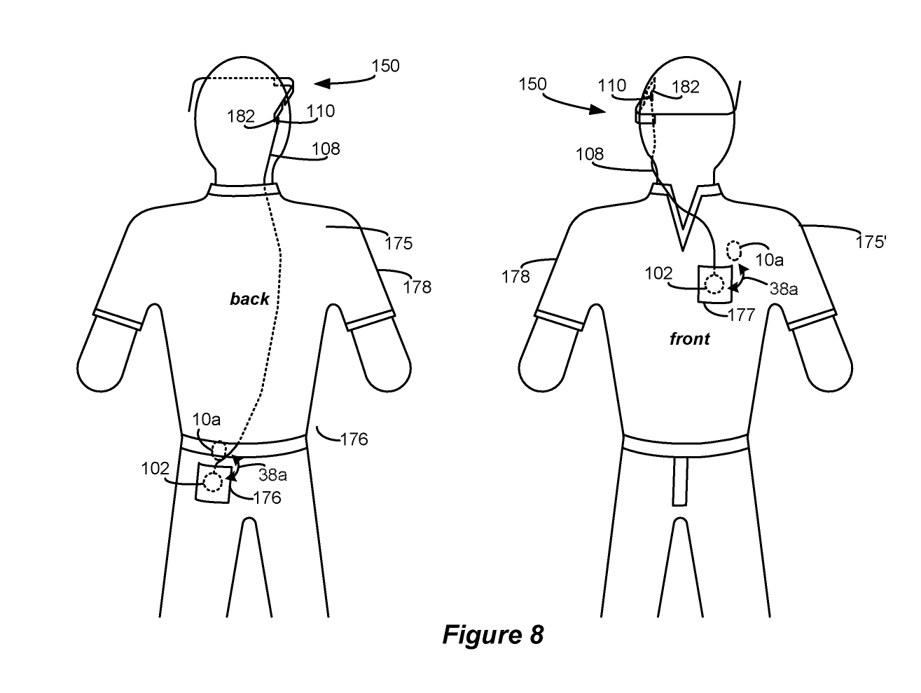

FIG. 8 shows how the use of the OHMD 150 and the IMD communication accessory 100 convenience a patient having an IMD 10a with a magnetic-induction telemetry communication coil 34a (FIG. 2A). Because magnetic induction communications along communication link 38a are relatively short distance (e.g., about 12 inches), it is useful to position the accessory's housing 102 and its charging coil 116 proximate to the location where IMD 10a is implanted in the patient.

Convenient manners in which this can occur are shown for both a Spinal Cord Stimulation (SCS) IMD patient 175 having an IMD 10a implanted in the upper buttocks, and a Deep Brain Stimulation (DBS) IMD patient 175′ having an IMD 10a implanted under the collar bone. The SCS IMD patient 175 can for example put the housing 102 of the accessory 100 in his back pants pocket 176, and fish cable 108 under the back of his shirt 178 and up through his shirt collar, where he can then connect USB connector 110 to the USB port 182 on his OHMD 150. The DBS patient 175′ can for example put the housing 102 of the accessory 100 in his front shirt pocket 177, and fish cable 108 (perhaps through shirt 178) to where the connector 110 can again be coupled to port 182. The length of cable 108 can be made differently in each of the accessories depending on its application and the size of the patient to make the cable 108 less noticeable.

These illustrations of how the accessory 100 can be worn by the patient are merely examples; carrying belts or harnesses for housing 102 worn over or under the patient's clothing can be used as well, and perhaps in manners that better hide the cable 108. Regardless, note that the housing 102 of the accessory 100 need not be perfectly aligned with the implanted location of the IMD 10a, but merely close enough to allow for reliable magnetic induction (e.g., FSK) communications. In either case, the patient 175 or 175′ utilizing the disclosed system retains full mobility and the ability to continually control and/or monitor his IMD 10a via the OHMD 150 that he is already wearing, and presumably using for other reasons.

FIG. 9 shows an example of the MDA GUI 195 rendered by the MDA 192 in the OHMD 150, which the patient can use to control and/or monitor his IMD. In the example illustrated, the patient can control inter alia various waveform parameters, such as the amplitude (A), duration (D), and frequency (F) of the stimulation pulses provided by his IMD. Other aspects of IMD control, such as selection of particular electrodes 16 and their polarities, are not shown for simplicity. As one example of IMD monitoring using the MDA GUI 195, electrode impedance is also provided by the MDA GUI 195, as explained below.

The MDA GUI 195 rendered in the example of FIG. 9 comprises a series of cards 200. In this example, the patient can only view one card at a time, but may navigate between cards and enter new stimulation parameter values using the touch pad 166 (FIG. 5A) on the OHMD 150. Voice inputs and user gestures can also be used for navigation and data entry as explained further below.

The first card 200 in the MDA GUI 195 illustrates and allows control of the waveform parameters A, D, and F of the patient's current stimulation program, i.e., Program 1, which stimulation programs can read by MDA 192 as stored in memory in the OHMD 150 or in the IMD 10a or 10b. This first card 200 may be the first presented to the patient via the MDA GUI 195, or may be a card that is later arrived at starting from an initial home screen of the MDA GUI 195. Shown in this first card is a cursor 202, which at present highlights the amplitude parameter A used in Program 1.

In this example, the cursor 202 is moved by swiping up and down on the touch pad 166, while parameter values are increased or decreased by swiping forward or backward on the touch pad 166. Upon review of the first card 200, the patient wishes to increase the amplitude for Program 1, which is already highlighted by the cursor 202 and currently set to 2.2 mA. Thus, the patient swipes forward on the touch pad 166 to increase this value by a set amount or increment, and so is now adjusted to 2.4 mA. Such changes implemented at the MDA GUI 195 are sent immediately to the IMD 10 as a command. Specifically, the OHMD 150's microcontroller 190 sends the updated amplitude data to its USB port 182, which is sent via connector 110 and the data lines in the cable 108 to the IMD communication accessory 100, and ultimately to its transceiver circuitry 130. The transceiver circuitry 130 modulates it and drives communication coil 116 appropriately for wireless transmission of the data on magnetic induction link 38a.

In a next card of the OHM GUI 195, the patient has swiped backward on the touch pad 166, which decreases the amplitude value back to 2.2 mA, which new value will again be telemetered to the IMD 10 via the accessory 100. A downward swipe moves the cursor 202 to the duration parameter (D), which is currently set to 100 ms, but which can also be similarly adjusted. A forward swipe increases its value to 110 ms which new value is again sent to the IMD 10. Two upward swipes at this point places the cursor 202 on the stimulation program, which too can be changed. For example a forward swipe brings up the waveform parameters for Program 2, which new parameters would also be sent to the patient's IMD 10 and can be adjusted.

A tapping action on the touch pad 166 can also be used to provide different navigation or control capabilities in the MDA GUI 195. In the example shown a “double tap”—two quick successive taps—changes the stimulation parameters accessible for the current program, and specifically allows the patient to change an advanced stimulation setting for the current program, namely the duty cycle.

After that parameter is changed (not shown), another double tap might allow the patient to monitor IMD parameters, such as electrode impedances as just one example. When this card is selected, the MDA GUI 195 can command the IMD 10 via the accessory 100 to run an electrode impedance test, or to otherwise provide electrode impedance data already taken and stored recently by the IMD 10. The IMD can then telemeter such data to the communication coil 116 in the accessory 110 via link 38a. The accessory transceiver 130 will demodulate the received data, and transmit it to the OHMD 150 via the cable 108. The MDA 192 can in turn render the received data value in the MDA GUI 195 as shown. Again, this is merely one example of IMD monitoring enabled by MDA GUI 195, and other IMD data can be similarly monitored as well.

FIG. 9 merely provides a simple non-limiting example of an MDA GUI 195 for the MDA 192 operating in the OHMD 150 in conjunction with the IMD communication accessory 100. The data displayed and controlled, the manner in which it is presented, the organization of the data on cards 200 or other GUI structures, the manners of selection and control of the MDA GUI 195, can be changed to suit the environment at hand. If the OHMD 150 comprises the Google Glass device previously mentioned, the development of MDA GUI 195 is facilitated by the Google Glass Developers Kit, which is available at https://developers.google.com/glass/. An XML programming language may be used to program a GUI such as MDA GUI 195 of the OHMD 150.

The input interface of the MDA GUI 195 is preferably not limited to touch inputs such as enabled by the touch pad 166. One or more buttons on the OHMD 150 may be used as well both for MDA GUI 195 navigation and for data entry or adjustment. Additionally, navigation and data entry and adjustment can also be spoken by the user and received by the OHMD 150′s microphone 168, and processed by the OHMD 150's voice detection module. Voice input may therefore be used by the MDA GUI 195 to form a command to be transmitted to the IMD 10. For example, the patient upon reviewing the first card 200 in FIG. 9 may change the amplitude by speaking “OK, Glass. Increase amplitude,” or “Amplitude equals 2.4,” which command can be transmitted to the IMD 10 for action as discussed previously. The patient may also navigate the MDA GUI 195 using voice inputs, such as by speaking “next value,” next card,” “Program 2,” etc.

The motion detectors in the OHMD 150 (accelerometers and/or gyroscopes) additionally allow for input to the MDA GUI 195 via user gestures. For example, instead of swiping right and left, or up and down on the touch pad 166 to navigate or enter data, user input could similarly be effected by the user turning his head to the right or left, or up and down.

Nor preferably is the MDA GUI 195 limited to providing viewable graphical outputs (using the display portion 170 and LED array 172 for example). Other user-discernable outputs can be audibly rendered as part of the MDA GUI 195 using the OHMD 150's audio transducer 164 or speaker. For example, the patient might instruct (by touch, voice, or gesture) the OHMD 150 to provide an audible summary of the stimulation parameters, which may prompt the MDA GUI 195 to audibly broadcast “Amplitude equals 2.2; duration equals 100; frequency equals 40; cathodes equal E6 and E7; anodes equal E8.” Such audibly-rendered information is particularly useful if the information is not presently being display by the MDA GUI 195 on the display portion 170, on a card 200 for instance. Audible presentation to the user can also include monitoring information transmitted from the IMD 10. For example, electrode impedances once received by the MDA 192 can be spoken to the patient by the MDA GUI 195, for example “Electrode E1=X; Electrode E2=Y,” etc., or “Electrode impedances within limits.” A vibratory motor or other tactile means of output in the OHMD 150 can also be used to provide information to the patient via MDA GUI 195.

If the patient's IMD uses short-range RF communication means, such as IMD 10b (FIG. 2B) with its short-range RF antenna 34b, then the IMD communication accessory used with the OHMD 150 can be configured differently. For example, a patient's IMD 10b may include medical-device-specific short-range RF communication means, such as an antenna 34b and telemetry circuitry 28b compliant with the MICS standard. OHMD 150 wouldn't normally be configured to handle this sort of short-range RF telemetry, and hence the accessory would in this instance be configured to convert IMD communication to this format.

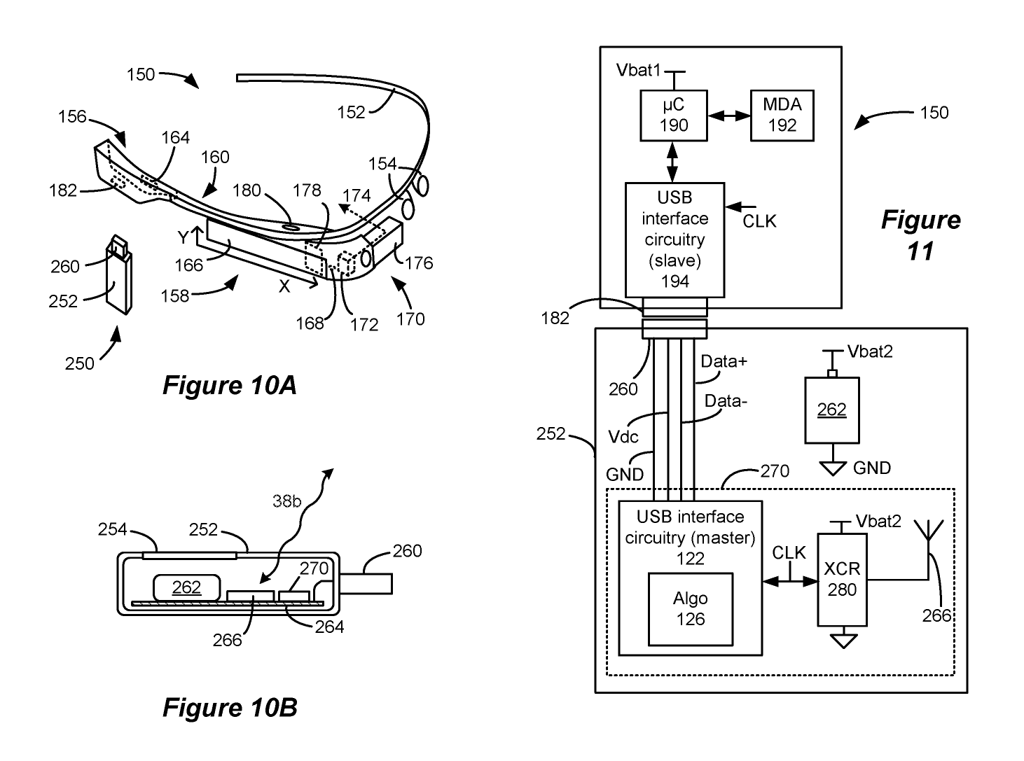

Such an IMD communication accessory 250 is shown in FIG. 10A and in FIG. 10B in cross section, and generally comprises a “dongle” or “stick” with a USB connector 260 coupleable to the USB port 182 on the OHMD 150. The accessory 250 can contain many of the same basic components as the accessory 100 introduced earlier, including a housing 252, a PCB 264, a battery 262, an optional battery cover 254, and various circuitry 270. Battery 262 may again be rechargeable, although this isn't shown. Circuitry 270, shown in detail in FIG. 11, again includes master USB interface circuitry 112 and algorithm 126, which can operate as before. Communication circuitry though has changed to handle MICS communications via a MICS-compliant short-range RF antenna 266 and transceiver circuitry 280 in the housing 252 compliant with communication with the IMD 10b on communication link 38b. Antenna 266, like antenna 34b in the IMD 10b, can comprise a patch, slots, wire, etc., and can operate as a dipole or a monopole. Further, antenna 266 may also be positioned outside or on the external surface of the housing 252. Moreover, although it is preferred that the accessory 250 have its own battery 262, this is not strictly necessary, and instead the accessory 250 may receive power from the OHMD 150 (e.g., its battery; not shown).

Again, battery 262 in the housing 252 can power the transceiver circuitry 280 and antenna 266, and therefore the IMD communication accessory 250 doesn't need to rely on the OHMD 150 for power, and won't drain the OHMD's battery (Vbat1).

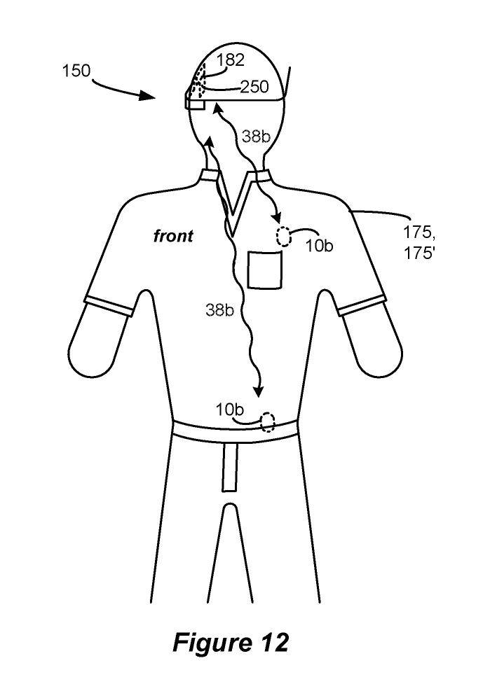

Because short-range RF communications enabled by accessory 250 occur at longer distances, the accessory 250 can merely be mechanically coupled to and hang from the USB port 182 on the OPHM 150. That is, a longer cable (compare 208; FIG. 5A) is not needed to bring the accessory 250 and its antenna 266 close to the location where the IMD 10b is implanted. This is shown in FIG. 12, and given the range of short-range RF communications on link 38b, such coupling of the accessory 250 to the OHMD 150 will allow for patient monitoring and control wherever the IMD 10b is implanted. Implant locations for both an SCS IMD 10b and a DBS 10b are shown in FIG. 12. As such, the IMD communication assembly 250 has the benefit of being cableless, and thus less noticeable when connected to the OHMD 150 than the magnetic induction-based accessory 100 disclosed earlier. Again, which of accessories 100 or 250 is best used with the OHMD 150 ultimately depends on the communication means used in the IMD 10a or 10b.

Aside from differences in the physical configuration and communication means used, the IMD communication accessory 250 can function like accessory 100, with the MDA 192 generating an MDA GUI 195 (FIG. 9) to allow a patient to control and/or monitor his IMD 10b.

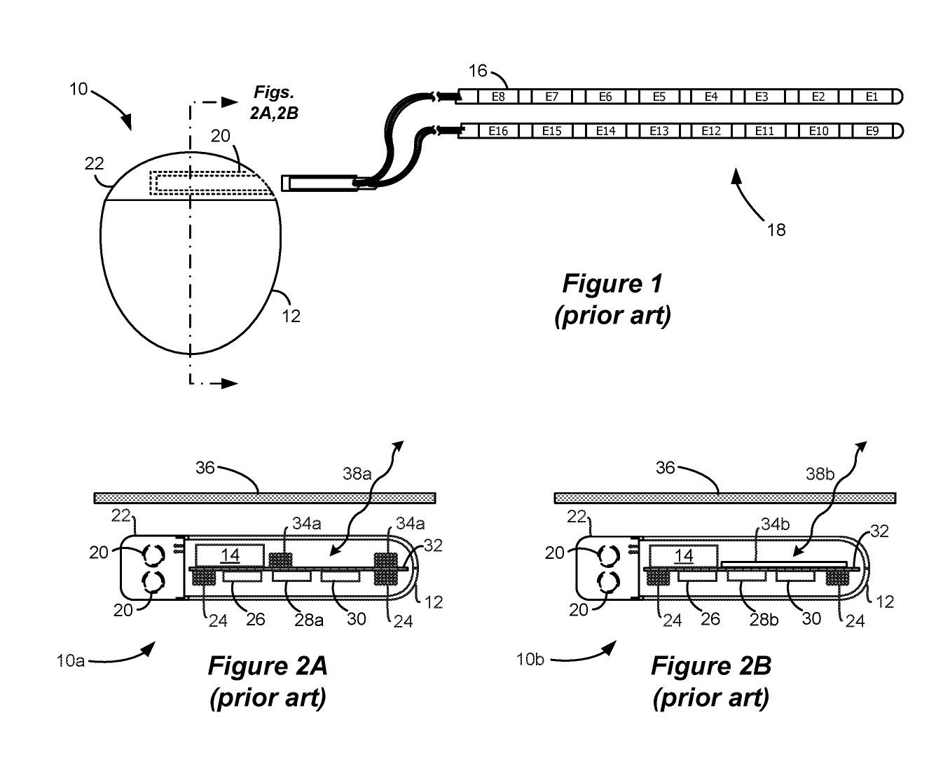

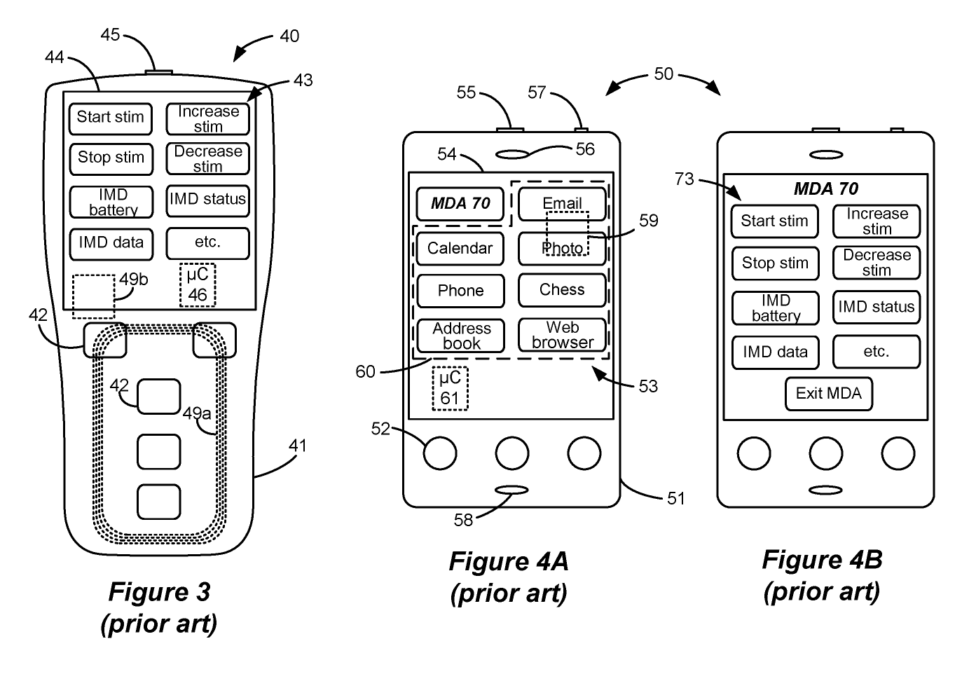

The disclosed systems may be useful in controlling and monitoring the operation of a more generic medical device, which medical device need not be implanted within a patient. For example, the OHM 150 and either of IMD communication accessories 100 or 250 may be used to control an External Trial Stimulator (ETS). As described in U.S. Patent Application Publication 2014/0358194, an ETS can be used to mimic operation of an IMD 10 during a trial period while the IMD leads 18 (FIG. 1) are implanted in the patient, but before implantation of the IMD case 12. The ETS during such a trial period is typically carried or worn by the patient, and couples to the exposed leads 18 via lead extensions (not shown). As the ETS can also mimic the communication means present in the to-be implanted IMD, the OHMD 150 and accessory 100/250 can control and/or monitor the ETS, which is useful in a clinical setting. The OHMD 150 and accessory 100/250 can also be used to control and/or monitor other external pulse generators, such as transcutaneous pulses generators (e.g., transcutaneous electrical nerve stimulators (TENS)), or other external medical devices more generally.

Microcontroller control circuitry operable in the OHMD 150 and in either of the accessories 100 or 250 (if necessary) can comprise for example Part Number MSP430, manufactured by Texas Instruments, which is described in data sheets at http://www.ti.com/lsds/ti/ microcontroller/16-bit_msp430/overview.page?DCMP=MCU_other& HQS=msp430, which is incorporated herein by reference. However, other types of control circuitry may be used in lieu of a microcontroller as well, such as microprocessors, FPGAs, DSPs, or combinations of these, etc.

Although particular embodiments have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A system, comprising:
a non-transitory machine-readable medium upon which are stored instructions for a medical device application (MDA) executable by an external device wearable by a patient, wherein the MDA when executed on the external device is configured to:
provide a Graphical User Interface (GUI) on the external device to control and/or monitor a medical device of the patient; and
a communication accessory, comprising:
at least one housing;
a battery within the housing;
an antenna;
transceiver circuitry within the at least one housing, wherein the antenna and transceiver circuitry are powered by the battery; and
a connector, wherein the connector is configured for connection to a port on the external device,
wherein the antenna is configured to be controlled by the GUI via the connector to wirelessly control and/or monitor the medical device.

2. The system of claim 1, wherein the antenna is within the at least one housing.

3. The system of claim 1, wherein the connector comprises a Universal Serial Bus (USB) connector.

4. The system of claim 3, wherein the accessory further comprises USB interface circuitry coupled to the connector.

5. The system of claim 1, wherein the battery is rechargeable.

6. The system of claim 1, wherein the antenna comprises a coil antenna, and wherein the coil antenna wirelessly controls and/or monitors the medical device via magnetic induction and in accordance with a modulation and/or demodulation scheme.

7. The system of claim 6, wherein the modulation and/or demodulation scheme comprises Frequency Shift Keying.

8. The system of claim 6, wherein the accessory further comprises a cable separating the connector and the housing.

9. The system of claim 1, wherein the antenna comprises an RF antenna, and wherein the RF antenna wirelessly controls and/or monitors the medical device via a short-range RF communication standard.

10. The system of claim 9, wherein the communication standard comprises MICS.

11. The system of claim 1, wherein the MDA when executed is configured to provide on the GUI a stimulation program provided to the medical device by the patient, and wherein the GUI is configured to receive the patient's input to adjust the stimulation program.

12. The system of claim 11, wherein the GUI is configured to receive the patient's input via one or more of touching the external device, receiving the patient's voice, or sensing the patient's gestures.

13. The system of claim 1, further comprising the external device, wherein the medical device application is stored in a non-transitory machine-readable medium of the external device.

14. The system of claim 1, further comprising the medical device.

15. The system of claim 14, wherein the medical device comprises an implantable pulse generator.

16. The system of claim 1, wherein the external device comprises an Optical Head-Mounted Display (OHMD).

17. A system, comprising:
an external device wearable by a patient, comprising:
a programmable Graphical User Interface (GUI) to allow the patient to control and/or monitor the medical device; and
a port; and
a communication accessory, comprising:
at least one housing;
a battery within the housing;
an antenna;
transceiver circuitry within the at least one housing, wherein the antenna and transceiver circuitry are powered by the battery; and
a connector, wherein the connector is configured for connection to the port on the external device,
wherein the antenna is configured to be controlled by the GUI via the connector to wirelessly control and/or monitor the medical device.

18. The system of claim 17, wherein the antenna is within the at least one housing.

19. The system of claim 17, wherein the connector comprises a Universal Serial Bus (USB) connector and the port comprises a USB port.

20. The system of claim 17, wherein the antenna comprises a coil antenna, and wherein the coil antenna wirelessly controls and/or monitors the medical device via magnetic induction and in accordance with a modulation and/or demodulation scheme.

21. The system of claim 20, wherein the accessory further comprises a cable separating the connector and the housing.

22. The system of claim 17, wherein the antenna comprises an RF antenna, and wherein the RF antenna wirelessly controls and/or monitors the medical device via a short-range RF communication standard.

23. The system of claim 17, wherein the external device further comprises a display portion for rendering the GUI in a manner viewable by the patient.

24. The system of claim 17, wherein the display portion is proximate to an eye of the patient.

25. The system of claim 17, wherein the GUI is configured to receive the patient's input via one or more of touching the external device, receiving the patient's voice, or sensing the patient's gestures.

26. The system of claim 17, wherein the external device further comprises a touch pad, and wherein the GUI is configured to receive the patient's touch at the touch pad.

27. The system of claim 17, wherein the external device comprises an Optical Head-Mounted Display (OHMD).
